(19) United States
(12) Patent Application Publication
(10) Pub. No.: US 2026/0164161 A1
(43) Pub. Date: Jun. 11, 2026

(54) HEADPHONE DEVICE, METHOD FOR PREVENTING HEADPHONE DEVICE FROM FALLING OFF, AND STORAGE MEDIUM

(71) Applicants: Fu Tai Hua Industry (Shenzhen) Co., Ltd., Shenzhen (CN); HON HAI PRECISION CO., LTD., New Taipei (TW)

(72) Inventors: XUE-LIANG XU, Shenzhen (CN); LEI-TONG YU, Shenzhen (CN)

(21) Appl. No.: 19/070,818

(22) Filed: Mar. 5, 2025

(30) Foreign Application Priority Data
Dec. 10, 2024 (CN) 202411810150.9

(51) Int. Cl. H04R 1/10; G08B 3/10

(52) U.S. Cl. CPC H04R 1/1041; G08B 3/10; H04R 1/1016; H04R 1/105; H04R 1/1058; H04R 2460/11

(57) ABSTRACT

The present application provides a method for preventing an earphone device from falling off. The method includes sensing an initial position of the earphone device in contact with an external auditory canal of a user. Once a real-time position of the earphone device in contact with the external auditory canal and a real-time pressure exerted by the external auditory canal on the earphone device are sensed, an adsorption mechanism of the earphone device is controlled to adsorb to the external auditory canal, when there is a deviation between the real-time position and the initial position, and/or the real-time pressure is lower than a preset threshold.

### TECHNICAL FIELD

The present application relates to a technical field of audio device, and in particular to a headphone device, a method for preventing the headphone device from falling off, and a storage medium.

### BACKGROUND

Headphone devices such as Bluetooth headsets are favored by many people. A traditional Bluetooth headset establishes a wireless connection with a terminal device to obtain and play audio. When a user is rigorously moving, such as running, cycling, dancing, etc., the traditional Bluetooth headset may fall off due to vibrations and/or impact.

To solve the above problems, a current Bluetooth headset usually enhances a fixation by adding a fixed accessory to prevent it from falling off, the fixed accessory may refer to an ear hook, an ear clip, and a connecting cable across a neck of the user. However, the fixed accessory may cause an additional pressure on the ear, reduce ear comfort of the user during use, and easily cause a damage to the Bluetooth headset during a strenuous exercise. In addition, when the user wears the Bluetooth headset, the ear is pressed by the fixed accessory for a long time, which is prone to pain, discoloration, lesions and other abnormalities, which brings an extremely bad use experience to the user.

### BRIEF DESCRIPTION OF THE DRAWINGS

FIG. 1 is a schematic diagram of a flowchart of a method for preventing an earphone device from falling off provided in an embodiment of the present application.

FIG. 2 is a schematic diagram of a structure of an earphone device provided in an embodiment of the present application.

FIG. 3 is a schematic diagram of an embodiment of an anti-falling apparatus for the earphone device shown in FIG. 2.

FIG. 4 is a schematic diagram of the earphone device provided in another embodiment of the present application.

Following embodiments of the present application will further illustrate the present application in conjunction with the above-mentioned drawings.

### DETAILED DESCRIPTION

The embodiments of the present application are described in detail below, and examples of the embodiments are shown in the accompanying drawings, where the same or similar reference numerals throughout represent the same or similar elements or elements having the same or similar functions. The embodiments described below with reference to the accompanying drawings are exemplary and are only used to explain the present application, and cannot be understood as limiting the present application.

In the embodiments of the present application, it should be noted that, unless otherwise clearly specified and limited, words such as “for example” are used to indicate examples, illustrations or explanations. Any embodiment or design described as “for example” in the embodiments of the present application should not be interpreted as being more preferred or more advantageous than other embodiments or designs. Specifically, the use of words such as “for example” is intended to present related concepts in a specific way.

In the description of the present application, it should be noted that, unless otherwise clearly specified and limited, terms “installed”, “being connected”, and “connected” should be understood in a broad sense. For example, it can be a fixed connection, a detachable connection, or an integral connection; it can be a mechanical connection, an electrical connection, or a mutual communication; it can be a direct connection, or an indirect connection through an intermediate medium, it can be the internal connection of two elements or the interaction relationship between two elements. For ordinary skilled in the art, specific meanings of the above terms in this application can be understood according to specific circumstances.

In the description of the present application, it should be noted that, unless otherwise expressly specified and limited, the terms “first” and “second” are used for descriptive purposes only and cannot be understood as indicating or implying relative importance or implicitly indicating the number of technical features indicated. Therefore, the features defined as “first” and “second” may explicitly or implicitly include one or more of the features. In addition, in the description of the present application, the meaning of “a plurality of” is two or more, unless otherwise clearly and specifically limited.

In order to more clearly understand the above-mentioned purpose, features and advantages of the present application, the present application is described in detail below in conjunction with the accompanying drawings and specific embodiments. It should be noted that the embodiments of the present application and the features in the embodiments can be combined with each other without conflict.

At present, a headphone device such as a Bluetooth headset usually enhances a fixation by adding a fixed accessory to prevent it from falling off, the fixed accessory may refer to an ear hook, an ear clip, and a connecting cable across a neck of the user. However, the fixed accessory may cause an additional burden on the ear, reduce ear comfort of the user during use, and easily cause a damage to the Bluetooth headset during a strenuous exercise. In addition, when the user wears the Bluetooth headset, the ear of the user is pressed by the fixed accessory for a long time, which is prone to pain, discoloration, lesions and other abnormalities, which brings an extremely bad user experience to the user.

In view of the above, the present application provides a headphone device, and a method for preventing the earphone device from falling off, so as to solve the above-mentioned technical problems.

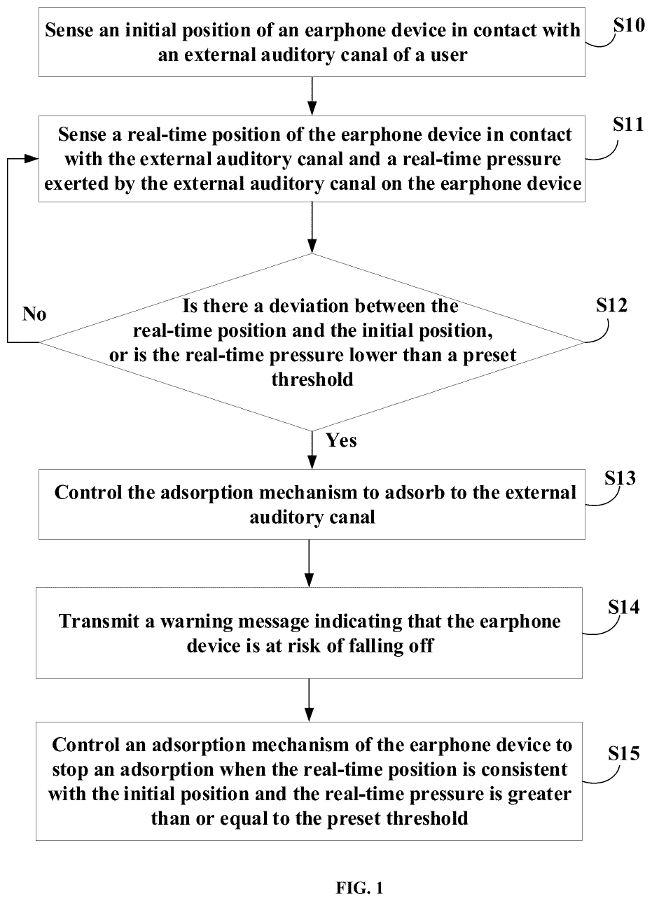

Please refer to FIG. 1, which is a schematic diagram of a flowchart of a method for preventing an earphone device from falling off provided in this embodiment.

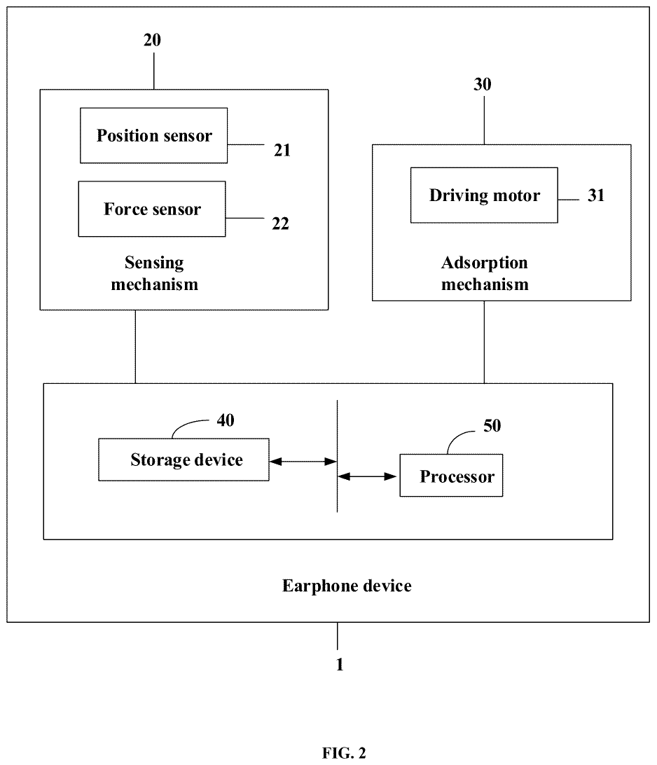

The method for preventing the earphone device from falling off provided in the embodiment of the present application is applied to one or more earphone devices 1 (as shown in FIG. 2). The earphone device 1 is a device that can automatically perform numerical calculations and/or information processing according to pre-set or stored instructions, and its hardware includes but is not limited to a microprocessor, an application specific integrated circuit (ASIC), a field-programmable gate array (FPGA), a digital signal processor (DSP), an embedded device, etc.

In other embodiments, the headset device 1 can be communicatively connected to a device such as a smart phone, a desktop computer, a notebook, a PDA, or a cloud server.

Referring to FIG. 2, in some embodiments, the earphone device 1 includes a sensing mechanism 20 and an adsorption mechanism 30. The sensing mechanism 20 is used to sense a position that the earphone device 1 contacts an external auditory canal of a user and to sense a pressure exerted by the external auditory canal on the earphone device 1.

Specifically, the method for preventing the earphone device 1 from falling off includes following blocks. According to different requirements, an order of some blocks in the flowchart can be changed, and some blocks can be omitted.

S10, an initial position of the earphone device 1 in contact with an external auditory canal of a user is sensed through the sensing mechanism 20.

In some embodiments, after the user correctly wears the earphone device 1 in the external auditory canal, the sensing mechanism 20 senses the initial position of the earphone device 1 in contact with the user's external auditory canal.

In some embodiments, the sensing mechanism 20 may include a position sensor 21. Specifically, the position sensor 21 is used to sense the initial position where the earphone device 1 contacts the external auditory canal of the user.

S11, a real-time position of the earphone device 1 in contact with the external auditory canal and a real-time pressure exerted by the external auditory canal on the earphone device 1 are sensed through the sensing mechanism 20.

In some embodiments, the sensing mechanism 20 may further include a force sensor 22. Specifically, the position sensor 21 senses the real-time position of the earphone device 1 in contact with the user's external auditory canal, and the force sensor 22 senses the real-time pressure applied by the external auditory canal to the earphone device 1.

S12, Determining whether there is a deviation between the real-time position and the initial position, and/or whether the real-time pressure is lower than a preset threshold.

In some embodiments, when there is the deviation between the real-time position and the initial position, and/or when the real-time pressure is lower than the preset threshold, block S13 is executed.

In some embodiments, when the real-time position is consistent with the initial position and the real-time pressure is greater than or equal to the preset threshold, the process returns to block S11 to perform a next round of sensing.

S13, the adsorption mechanism 30 is controlled to adsorb to the external auditory canal.

In some embodiments, the adsorption mechanism 30 may include a driving motor 31. Specifically, controlling the adsorption mechanism 30 to adsorb to the external auditory canal includes: feeding back a high-level power supply signal to the driving motor 31, and starting the driving motor 31 to make the adsorption mechanism 30 adsorb to the external auditory canal.

The method for preventing the earphone device 1 from falling off in the above-mentioned embodiment can automatically predict a falling risk of the earphone device 1, and then when the earphone device 1 is about to fall off, the external auditory canal is adsorbed by the adsorption mechanism 30, thereby fixing the earphone device 1 to prevent the earphone device 1 from being lost. No external fixing accessories are needed to prevent external fixing accessories from causing ear lesions, thereby improving the user experience.

In some embodiments, the method for preventing the earphone device 1 from falling off further includes the following blocks after the block S13:

S14, a warning message indicating that the earphone device 1 is at risk of falling off is transmitted.

In some embodiments, warning information indicating that the earphone device 1 is at risk of falling off may be sent to a terminal device to which the earphone device 1 is connected.

The method for preventing the earphone device 1 from falling off in the above embodiment sends out the warning message that the earphone device 1 is at risk of falling off, which can remind the user to put on the earphone device again in time, which not only reduces the risk of losing the earphone device, but also improves the user experience and a safety of the earphone device 1.

In some embodiments, the method for preventing the earphone device 1 from falling off further includes the following blocks after block S14:

S15, when the real-time position is consistent with the initial position and the real-time pressure is greater than or equal to the preset threshold, the adsorption mechanism 30 is controlled to stop an adsorption.

In some embodiments, controlling the adsorption mechanism 30 to stop the adsorption includes: feeding back a low-level power supply signal to the drive motor 31, and turning off the drive motor 31 to make the adsorption mechanism 30 stop adsorption.

In the method for preventing the headphone device 1 from falling off in the above embodiment, after the warning information is transmitted, when the real-time position is consistent with the initial position and the real-time pressure is greater than or equal to the preset threshold, it indicates that the user has put on the headphone device 1 snugly again after being reminded by the warning information. At this time, the adsorption mechanism 30 does not need to continue to adsorb, which reduces power consumption and improves a battery life of the headphone device 1.

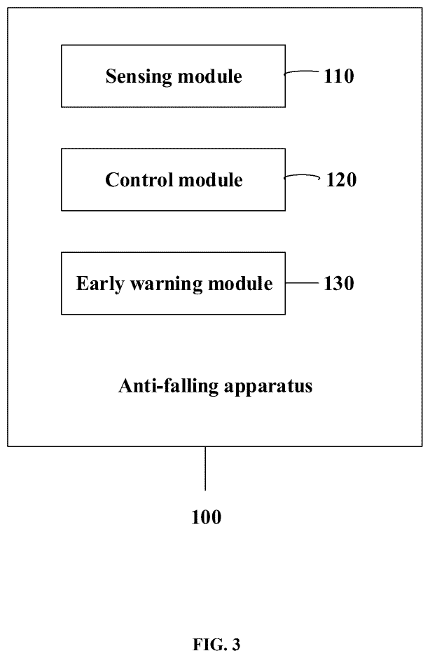

As shown in FIG. 3, it is a structure diagram of an anti-falling apparatus 100 of an earphone device 1 provided in an embodiment of the present application.

In this embodiment, based on the same concept as the method for preventing the earphone device 1 from falling off in the above embodiment, the present application also provides the anti-falling apparatus 100 of the earphone device 1, which can be used to perform the method for preventing the earphone device 1 from falling off. For ease of explanation, the structure diagram of the anti-falling apparatus 100 only shows parts related to the embodiment of the present application. Those skilled in the art can understand that the illustrated structure does not constitute a limitation on the anti-falling apparatus 100 of the earphone device 1, and may include more or fewer components than shown in the diagram, or combine certain components, or arrange the components differently.

Specifically, the anti-falling apparatus 100 of the earphone device 1 provided in the embodiment of the present application includes a sensing module 110, a control module 120, and an early warning module 130.

The sensing module 110 is used to sense the initial position where the earphone device 1 contacts the external auditory canal of the user through the sensing mechanism 20.

In some embodiments, after the user correctly wears the earphone device 1 in the external auditory canal, the sensing mechanism 20 senses the initial position where the earphone device 1 contacts the user's external auditory canal.

In some embodiments, the sensing mechanism 20 may include the position sensor 21. Specifically, the position sensor 21 is used to sense the initial position where the earphone device 1 contacts the external auditory canal of the user.

The sensing module 110 is also used to sense the real-time position of the earphone device 1 in contact with the external auditory canal and sense the real-time pressure applied by the external auditory canal to the earphone device 1 through the sensing mechanism 20.

In some embodiments, the sensing mechanism 20 may further include the force sensor 22. Specifically, the position sensor 21 senses the real-time position of the earphone device 1 in contact with the user's external auditory canal, and the force sensor 22 senses the real-time pressure applied by the external auditory canal to the earphone device 1.

The control module 120 is used to control the adsorption mechanism 30 to adsorb to the external auditory canal when there is the deviation between the real-time position and the initial position, and/or when the real-time pressure is lower than the preset threshold.

In some embodiments, the adsorption mechanism 30 may include the driving motor 31. Specifically, controlling the adsorption mechanism 30 to adsorb to the external auditory canal includes: feeding back the high-level power supply signal to the driving motor 31, and starting the driving motor 31 to make the adsorption mechanism 30 adsorb to the external auditory canal.

The anti-falling apparatus 100 of the earphone device 1 of the above-mentioned embodiment can automatically predict the risk of the earphone device 1 falling off, and then when the earphone device 1 is about to fall off, the external auditory canal is adsorbed by the adsorption mechanism 30, so as to fix the earphone device 1 and prevent the earphone device 1 from being lost. No external fixing accessories are needed to prevent external fixing accessories from causing ear lesions, thereby improving the user experience.

The warning module 130 is used to transmit the warning message indicating that the earphone device 1 is at risk of falling off when there is the deviation between the real-time position and the initial position, and/or when the real-time pressure is lower than the preset threshold.

In some embodiments, warning information indicating that the earphone device 1 is at risk of falling off may be sent to the terminal device to which the earphone device 1 is connected.

The anti-falling apparatus 100 of the earphone device 1 in the above embodiment sends out the warning message that the earphone device 1 is at risk of falling off, which can remind the user to put on the earphone again in time, which not only reduces the risk of losing the earphone, but also improves the user experience and the safety of the earphone device 1.

The anti-falling apparatus 100 is also used to control the adsorption mechanism 30 to stop adsorption when the real-time position is consistent with the initial position and the real-time pressure is greater than or equal to the preset threshold.

In some embodiments, controlling the adsorption mechanism 30 to stop adsorption includes: feeding back the low-level power supply signal to the drive motor 31, and turning off the drive motor 31 to make the adsorption mechanism 30 stop adsorption.

In the anti-falling apparatus 100 of the headphone device 1 in the above embodiment, after the warning information is transmitted, when the real-time position is consistent with the initial position and the real-time pressure is greater than or equal to the preset threshold, it indicates that the user has put on the headphone device 1 again after being reminded by the warning information. At this time, the adsorption mechanism 30 does not need to continue to adsorb, which reduces power consumption and improves the battery life of the headphone device 1.

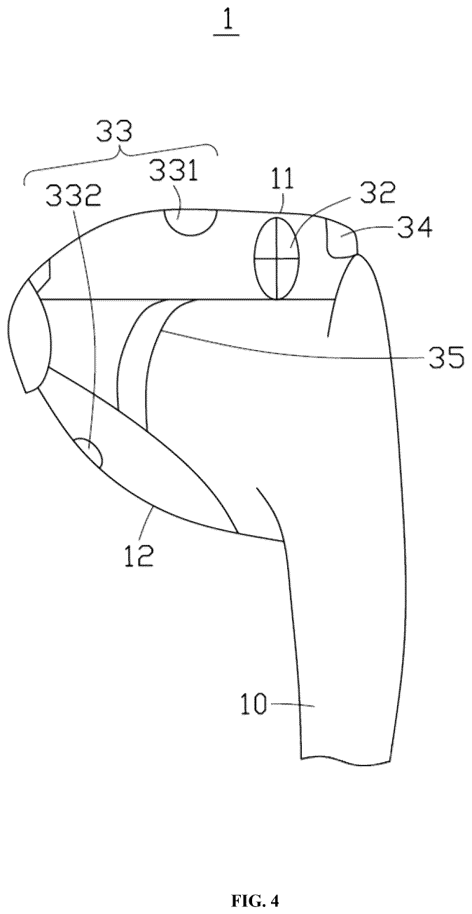

As shown in combination with FIG. 2 and FIG. 4, the earphone device 1 includes: an earphone body 10, the sensing mechanism 20, the adsorption mechanism 30, a storage device 40, a processor 50, and an anti-falling program of the earphone device 1 stored in the storage device 40 and executable on the processor 50. When the anti-falling program of the earphone device 1 is executed by the processor 50, the method for preventing the earphone device 1 from falling off in the above-mentioned embodiment is implemented. The sensing mechanism 20 is provided on the earphone body 10, and the sensing mechanism 20 is used to sense the position of the earphone body 10 in contact with the external auditory canal of the user and sense the pressure exerted by the external auditory canal on the earphone body 10. The adsorption mechanism 30 is provided on the earphone body 10, and the adsorption mechanism 30 is used to adsorb to the external auditory canal.

In some embodiments, a surface of the earphone body 10 that contacts the external auditory canal is provided with a plurality of suction holes 33 and a plurality of exhaust holes 34. The adsorption mechanism 30 includes at least one ventilation duct (not shown), a fan blade 32, and the drive motor 31. The at least one ventilation duct connects the plurality of suction holes 33 and the plurality of exhaust holes 34. The fan blade 32 is configured near the plurality of exhaust holes 34. The drive motor 31 is used to drive the fan blade 32 to rotate, when the fan blade 32 is driven to rotate by the driving motor 31, gas in the at least one ventilation duct is propelled out of the at least one ventilation duct, so that the plurality of suction holes 33 generate suction, i.e., the plurality of suction holes is adsorbed to the external auditory canal.

In some embodiments, the surface of the earphone body 10 includes a first surface 11 and a second surface 12. The plurality of suction holes 33 include a first suction hole 331 disposed on the first surface 11 and a second suction hole 332 disposed on the second surface 12. The at least one ventilation duct includes a first ventilation duct (not shown) and a second ventilation duct (not shown), the first ventilation duct is connected to the first suction hole 331, and the second ventilation duct is connected to the second suction hole 332. The adsorption mechanism 30 also includes an exhaust pipe 35. The exhaust pipe 35 connects the first ventilation duct and the second ventilation duct, and the exhaust holes 34 are connected to the first ventilation duct or the second ventilation duct.

In some embodiments, by using the first suction hole 331 set on the first surface 11 and the second suction hole 332 set on the second surface 12 to adsorb the external auditory canal, an upper side and a lower side of the earphone device 1 can be fixed, thereby improving a fixing performance of the earphone device 1 and further reducing the risk of falling off.

In some embodiments, the first ventilation duct and the second ventilation duct are connected by the exhaust pipe 35 to achieve a gas circulation between the first suction hole 331 and the second suction hole 332, thereby realizing a space utilization without increasing a volume of the earphone device 1.

In some embodiments, the at least one ventilation duct and the exhaust pipe 35 are both made of hard plastic material, which has the advantages of being easy to shape and light weight, thereby avoiding adding a weight burden to the earphone device 1.

The present application can automatically predict the risk of the earphone device 1 falling off, and then when the earphone device 1 is about to fall off, the adsorption mechanism 30 adsorbs to the external auditory canal, thereby fixing the earphone device 1 to prevent the earphone from being lost, without a need for external fixing accessories, and preventing the external fixing accessories from causing ear lesions, thereby improving the user experience.

Those skilled in the art may appreciate that the schematic diagram is merely an example of the headphone device 1 and does not constitute a limitation of the headphone device 1. The headphone device 1 may include more or fewer components than shown in the diagram, or a combination of certain components, or different components. For example, the headphone device 1 may also include input and output devices, a network access device, a bus, etc.

The processor 50 executes an operating system and various computer programs in the earphone device 1. The processor 50 executes the computer program such as the anti-falling program to implement the method for preventing the earphone device 1 from falling off, such as the blocks shown in FIG. 1

Exemplarily, the computer program may be divided into one or more modules/units, one or more modules/units are stored in the storage device 40, and are obtained by the processor 50 to complete the present application. One or more modules/units may be a series of instruction segments of the computer program capable of completing specific functions, and the instruction segments are used to describe the acquisition process of the computer program in the headphone device 1.

In some embodiments, the headphone device 1 includes a device that can automatically perform numerical calculations and/or information processing according to pre-set or stored instructions. The hardware of the headphone device 1 includes, but is not limited to, a microprocessor, an application specific integrated circuit (ASIC), a field-programmable gate array (FPGA), a digital signal processor (DSP), an embedded device, etc.

In some embodiments, a network where the headset device 1 is located includes, but is not limited to: the Internet, a wide area network, a metropolitan area network, a local area network, a virtual private network (VPN), etc.

In some embodiments, the storage device 40 is used to store program codes and various data, such as the anti-falling apparatus 100 installed in the headphone device 1, and to achieve a high-speed and automatic access to programs or data during the operation of the headphone device 1. The storage device 40 may include a read-only memory (ROM), a random access memory (RAM), a programmable read-only memory (PROM), an erasable programmable read-only memory (EPROM), a one-time programmable read-only memory (OTPROM), an electronically erasable programmable read-only memory (EEPROM), a compact disc read-only memory (CD-ROM) or other optical disc storage, magnetic disk storage, magnetic tape storage, or any other computer-readable medium capable of carrying or storing data.

In some embodiments, the storage device 40 may also be an external storage device and/or an internal storage device of the headphone device 1. Furthermore, the storage device 40 may be a physical memory, such as a memory stick, a trans-flash card (TF) card, and the like.

In some embodiments, the processor 50 may be a central processing unit (CPU), or other general-purpose processors, digital signal processors (DSP), application-specific integrated circuits (ASIC), field-programmable gate arrays (FPGA) or other programmable logic devices, discrete gate or transistor logic devices, discrete hardware components, etc. The general-purpose processor may be a microprocessor or any conventional processor, etc. The processor 50 is a computing core and a control center of the headphone device 1, and uses various interfaces and lines to connect various parts of the entire headphone device 1, and invokes the data stored in the storage device 40 to execute various functions of the headphone device 1 and process data, such as executing an anti-falling function of the headphone device 1.

In some embodiments, the processor 50 is used to obtain the operating system and various applications of the earphone device 1. For example, the processor 50 executes the anti-falling program of the earphone device 1 to implement the method for preventing the earphone device 1 from falling off shown in FIG. 1.

In one embodiment of the present application, the headphone device 1 may also include a power supply (not shown) for supplying power to each component of the headphone device 1. Preferably, the power supply may be logically connected to the processor 50 through a power management device, so that the power management device can manage charging, discharging, and power consumption. The power supply may also include one or more DC or AC power supplies, recharging devices, power failure detection circuits, power converters or inverters, power status indicators, and other arbitrary components. The headphone device 1 may also include a variety of sensors, Bluetooth modules, Wi-Fi modules, etc., which will not be described in detail here.

In one embodiment of the present application, if the module/submodule integrated in the headphone device 1 is implemented in a form of a software functional submodule and sold or used as an independent workpiece, it can be stored in a computer-readable storage medium. Based on this understanding, the present application implements all or part of the processes in the above-mentioned embodiment method, and can also be completed by instructing the relevant hardware through a computer program. The computer program can be stored in a computer-readable storage medium. When the computer program is obtained by the processor 50, the blocks of the method embodiment shown in FIG. 1 can be implemented.

In one embodiment of the present application, the computer program may include computer program code, which may be in form of source code, in form of object code, an accessible file, or some intermediate form. The computer readable storage medium may include: any entity or device capable of carrying computer program code, recording medium, USB flash drives, mobile hard disks, magnetic disks, optical disks, computer memory, read-only memory (ROM), or any other medium capable of carrying computer program code.

The storage device 40 in the earphone device 1 stores a plurality of instructions to implement the method for preventing the earphone device 1 from falling off, and the processor 50 may obtain the plurality of instructions to implement the method for preventing the earphone device 1 from falling off in the above-mentioned embodiment.

Specifically, the specific implementation method of the processor 50 for the above instructions can refer to the description of the relevant blocks in the corresponding embodiment of FIG. 1, which will not be repeated here.

In the several embodiments provided in this application, it should be understood that the disclosed methods and devices can be implemented in other ways. For example, the device embodiments described above are only schematic, for example, the division of modules is only a logical function division, and there may be other division methods in actual implementation.

The modules described as separate components may or may not be physically separated, and the components shown as modules may or may not be physical units, that is, they may be located in one place or distributed on multiple network units. Some or all of the modules may be selected according to actual needs to achieve the purpose of the solution of this embodiment.

Each functional module in each embodiment of the present application can be integrated into a processing submodule, or each submodule can exist physically separately, or two or more submodules can be integrated into one submodule. The above-mentioned integrated submodule can be implemented in the form of hardware or in the form of hardware plus software functional modules.

Therefore, no matter from which point of view, the embodiments should be regarded as illustrative and non-restrictive, and the scope of the present application is limited by the appended claims rather than the above description, so it is intended that all changes falling within the meaning and scope of the equivalent elements of the claims are included in the present application. Any attached figure mark in the claims should not be regarded as limiting the claims involved.

In addition, it is obvious that the word “comprising” does not exclude other submodules or steps, and the singular does not exclude the plural. The multiple submodules or devices stated in this application can also be implemented by one submodule or device through software or hardware.

Finally, it should be noted that the above embodiments are only used to illustrate the technical solution of the present application and are not intended to limit it. Although the present application has been described in detail with reference to the preferred embodiments, a person of ordinary skill in the art should understand that the technical solution of the present application may be modified or replaced by equivalents without departing from the spirit and scope of the technical solution of the present application.

What is claimed is:

1. A method to prevent an earphone device from falling off, the earphone device comprising an adsorption mechanism, and the method comprising:
sensing an initial position of the earphone device in contact with an external auditory canal of a user;
sensing a real-time position of the earphone device in contact with the external auditory canal and sensing a real-time pressure exerted by the external auditory canal on the earphone device; and
in response that there is a deviation between the real-time position and the initial position, and/or the real-time pressure is lower than a preset threshold, controlling the adsorption mechanism to adsorb to the external auditory canal.

2. The method according to claim 1, further comprising:
in response that there is the deviation between the real-time position and the initial position, and/or the real-time pressure is lower than the preset threshold, transmitting a warning message indicating that the earphone device is at risk of falling off.

3. The method according to claim 1, wherein the adsorption mechanism comprises a driving motor, and controlling the adsorption mechanism to adsorb to the external auditory canal comprises:
feeding back a high-level power supply signal to the driving motor, and starting the driving motor to make the adsorption mechanism adsorb to the external auditory canal.

4. The method according to claim 3, wherein after controlling the adsorption mechanism to adsorb to the external auditory canal, the method further comprises:
in response that the real-time position is consistent with the initial position and the real-time pressure is greater than or equal to the preset threshold, controlling the adsorption mechanism to stop adsorption.

5. The method according to claim 4, wherein controlling the adsorption mechanism to stop adsorption comprises:
feeding back a low-level power supply signal to the driving motor, and turning off the driving motor to make the adsorption mechanism stop adsorption.

6. An earphone device comprising:
an earphone body; a sensing mechanism and an adsorption mechanism disposed on the earphone body;
a storage device; a processor; and an anti-falling program stored in the storage device, which when executed by the processor, causing the at least one processor to:
sense, by the sensing mechanism, an initial position of the earphone device in contact with an external auditory canal of a user;
sense, by the sensing mechanism, a real-time position of the earphone device in contact with the external auditory canal and a real-time pressure exerted by the external auditory canal on the earphone device; and
in response that there is a deviation between the real-time position and the initial position, and/or the real-time pressure is lower than a preset threshold, control the adsorption mechanism to adsorb to the external auditory canal.

7. The earphone device according to claim 6, wherein the earphone body comprises a plurality of suction holes and a plurality of exhaust holes, the plurality of suction holes and the plurality of exhaust holes are on a surface of the earphone body that is configured to be in contact with the external auditory canal, and the adsorption mechanism comprises:
at least one ventilation duct connected with the plurality of suction holes and the plurality of exhaust holes;
a fan blade arranged near the plurality of exhaust holes;
a driving motor connected to the fan blade and configured to drive the fan blade to rotate, wherein when the fan blade is driven to rotate by the driving motor, gas in the at least one ventilation duct is propelled out of the at least one ventilation duct, and the plurality of suction holes is adsorbed to the external auditory canal.

8. The earphone device as claimed in claim 7, wherein the surface of the earphone body further comprises a first surface and a second surface, the plurality of suction holes comprise a first suction hole arranged on the first surface and a second suction hole arranged on the second surface, the at least one ventilation duct comprises a first ventilation duct and a second ventilation duct, the first ventilation duct is connected to the first ventilation hole, and the second ventilation duct is connected to the second ventilation hole; the adsorption mechanism further comprises an exhaust pipe connected with the first ventilation duct and the second ventilation duct, the plurality of exhaust holes are connected with the first ventilation duct or the second ventilation duct.

9. A non-transitory storage medium having a computer program stored thereon, when the computer program is executed by a processor, a method for preventing an earphone device from falling off being implemented, the method comprising:
sensing an initial position of the earphone device in contact with an external auditory canal of a user;
sensing a real-time position of the earphone device in contact with the external auditory canal and sensing a real-time pressure exerted by the external auditory canal on the earphone device; and
in response that there is a deviation between the real-time position and the initial position, and/or the real-time pressure is lower than a preset threshold, controlling an adsorption mechanism of the earphone device to adsorb to the external auditory canal.

10. The non-transitory storage medium according to claim 9, wherein the method further comprises:
in response that there is the deviation between the real-time position and the initial position, and/or the real-time pressure is lower than the preset threshold, transmitting a warning message indicating that the earphone device is at risk of falling off.

11. The non-transitory storage medium according to claim 9, wherein the adsorption mechanism comprises a driving motor, and controlling the adsorption mechanism to adsorb to the external auditory canal comprises:
feeding back a high-level power supply signal to the driving motor, and starting the driving motor to make the adsorption mechanism adsorb to the external auditory canal.

12. The non-transitory storage medium according to claim 11, wherein after controlling the adsorption mechanism to adsorb to the external auditory canal, the method further comprises:
in response that the real-time position is consistent with the initial position and the real-time pressure is greater than or equal to the preset threshold, controlling the adsorption mechanism to stop adsorption.

13. The non-transitory storage medium according to claim 12, wherein controlling the adsorption mechanism to stop adsorption comprises:
feeding back a low-level power supply signal to the driving motor, and turning off the driving motor to make the adsorption mechanism stop adsorption.
